(19) United States
(12) Patent Application Publication
(10) Pub. No.: US 2013/0047879 A1
(43) Pub. Date: Feb. 28, 2013

(54) SYSTEM FOR PROTECTING AGAINST TERRORIST AND ILLEGAL INVASION

(71) Applicant: Franklin R. Lacy, Marco Island, FL (US)

(72) Inventor: Franklin R. Lacy, Marco Island, FL (US)

(21) Appl. No.: 13/221,649

(22) Filed: Aug. 30, 2011

(51) Int. Cl. F42B 12/36; F42B 30/10; F42B 23/00; F42B 25/00; C09K 3/00; G09F 7/00

(52) U.S. Cl. 102/382; 252/408.1; 102/473; 102/401; 40/584

(57) ABSTRACT

The system includes one or more devices to deter pig-blood sensitive terrorists' and others from passing across borders and across perimeters. It also deters similar terrorist suicide bombers. Sources of deterrence include pig blood derivatives in paint, spray, and detonation distribution form. In addition there are sources of deterrence from ampoules containing pig blood derivatives positioned in public buildings and on public transportation vehicles accompanied by appropriate signage.

### TECHNICAL FIELD

This invention relates generally to protection against terrorist invasion or suicide bombing threat by use of chemical means, and more specifically concerns a system of deterrence for preventing terrorist invasion across our borders and the borders of other countries. In addition, it will deter suicide bombers at/in airports, train stations, airplanes, or wherever people gather. It will also protect the perimeters of nuclear and other energy production facilities and military bases.

### BACKGROUND OF THE INVENTION

There is widespread recognition of the disastrous consequences of various terrorist groups sneaking across borders or into places where people gather, in order to commit suicide, blowing up themselves and others. These terrorists often do this with a belief of a heavenly reward.

Many systems and devices are known which attempt to contain and resolve this situation by screening out possible terrorists. This is very expensive and not reliable when it comes to the ever increasing numbers of terrorists and their ability to adapt and overcome prevention techniques. Accordingly, there is a significant present and ongoing need for a reliable system which is capable of preventing and/or containing terrorist invasion and suicide bombing by presenting a deterrence that the terrorists believe will keep them from the promised heavenly reward. The outcome will be that many lives will be saved.

### SUMMARY OF THE INVENTION

The present invention concerns deterrence for those terrorists whose religious or cultural teaching emphasize the threat of exposure to themselves of pig or monkey parts, i.e. a significant negative association or effect relative to contact with pig's blood in particular. These individuals are referred to herein as pig-blood sensitive terrorists. Even if the terrorist is dead, his or her remains that are/were in contact with pig or monkey blood will prevent that person from being in heaven because that is his/her religious/cultural training Even if the terrorist's remains are subjected to contact with pig or monkey blood after death, that person will fall out of heaven. The inventor learned this from extensive travels, including travel to many Middle Eastern countries.

The best approach is using ampoules, paints, and sprays of pig blood in a clingy preserved long-life suspension. This product can be applied to geographic areas, and it will keep pig-blood sensitive terrorists away. Printed, double-sided plaques labeling the pig blood in English, Arabic, and Farsi would accompany each application. The pig blood in ampoules would break under explosion. It will keep suicide bombers from blowing themselves up near the ampoule of pig blood because they believe that they would be guaranteed not to go to Heaven. The perimeter of nuclear facilities and other energy production facilities can be sprayed regularly and signs can be posted to indicate that the red color is pig blood in order to prevent pig-blood sensitive terrorist infiltrations. The U.S.A. border can be sprayed, and signs can also be posted at these locations. The Afghanistan border with Pakistan can be sprayed with plaques posted to prevent infiltration. The Israeli border can be sprayed to help eliminate terrorist infiltration. The perimeter of bases in foreign countries can be sprayed for additional protection.

Various mixtures of pig blood with stabilizers and clinginess can be employed; however, in the present configuration the preferred formula is one part pig blood combined with 1 part red dye, 2 parts alcohol, and 4 parts clear asphalt emulsion. The asphalt emulsion is oil base and provides the stickiness to cling to wherever it contacts and spread secondarily to additional contacts, including people. The pig blood and possibly the red dye are water based; although oil base red dyes can also be used. The alcohol allows the pig blood and red dye to spread into and throughout the clear asphalt emulsion. Alcohol also acts as a preservative. An oil base solvent and possibly heat may be added to bring the mixture to an aerial spraying consistency. The mixture can also be loaded into mortar shells, artillery shells, and bombs for an additional means of disbursement. The blood won't retain its color over time, so the red dye is necessary to more permanently remind terrorists of the disbursal zone. In ampoule form it can be placed in inverted dome shape glass which could be mounted by a peripheral flange to ceilings and walls of public buildings. In airplanes or trains, the ampoule containing the pig blood mixture could be more tubular in shape and mounted over seats. The signs labeling it as pig blood could be mounted next to each ampoule. The ampoules would cause others to be extra alert to report any suspicious occurrences.

### BRIEF DESCRIPTION OF THE DRAWINGS

FIG. 1 is a sketch of one ampoule.

FIG. 1A is an alternate sketch of an ampoule.

FIG. 2 is a sketch of a tubular, smaller ampoule although other configurations can be used. This version could be mounted over seats of public transportation vehicles. A mounted plaque near the ampoule would be similar to FIG. 3.

FIG. 3 is a sample of a marker plaque or a sign in English, Farsi, and Arabic. It would be printed on both sides for best results although some applications will only require single sided printing.

### BEST MODE FOR CARRYING OUT THE INVENTION

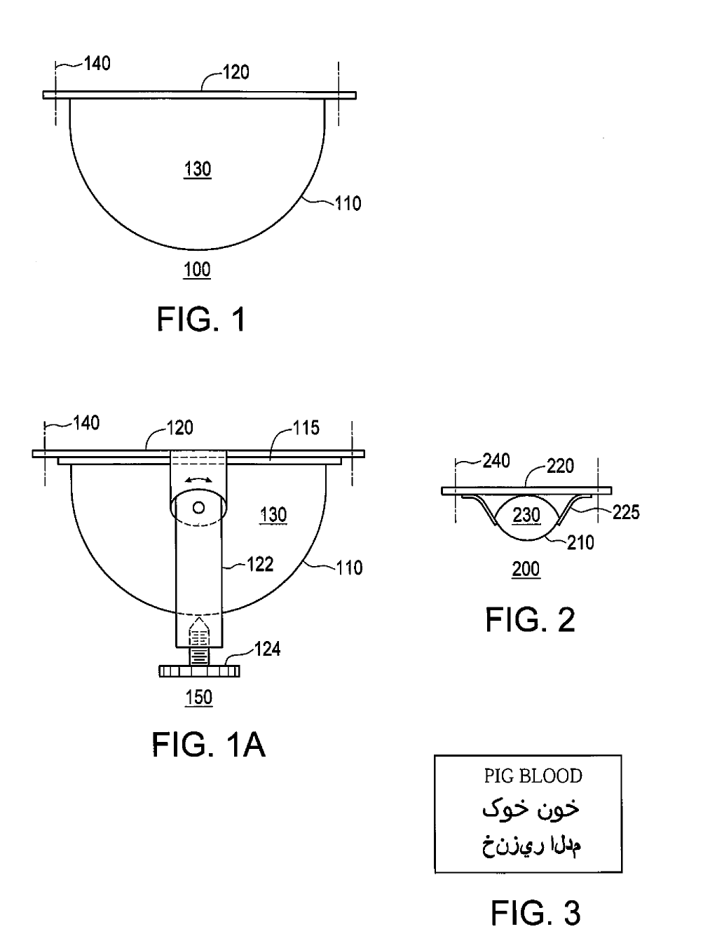

Referring now to FIG. 1 for a representation of the ampoule full of the pig blood mixture placed in an inverted dome approximately 4 inches in diameter for mounting to walls and ceilings of public buildings (100). The dome glass (110) will hold the pig blood mixture (130). The glass will have a perimeter widening to snugly drop into a flange (120). A glass top seals the dome (110). The flange (120) has perimeter mounting holes (140). In this instant the flange is made from aluminum; however, other materials will work equally well. Mounting bolt holes will accommodate ¼ inch diameter fasteners, but the holes can be drilled to accommodate other size fasteners. The thickness of the flange (120) is 0.12 inches and contains an inner circular bevel to accommodate the dome glass (110) at its widened perimeter bevel. Other flange thicknesses and widened dome glass perimeter shapes and mating will work equally well.

Referring now to FIG. 1A for an alternate representation of the ampoule full of the pig blood mixture placed in an inverted dome approximately 4 inches in diameter for mounting to walls and ceilings of public buildings (100). The dome glass (110) will hold the pig blood mixture (130). The glass will have an open top sealed against a disk shape seal (115) consisting of a rubber or cork or similar material to seal in the pig blood mixture where the dome meets the flange (120). Although the seal is disk shaped in this configuration, other shapes may be used for equal success. The seals dimensions are 1/16 inch thick by 4 ¼ inches in diameter in this instant; although other thicknesses and dimensions will work equally well. The glass dome (110) compresses against the top seal (115) by means of a yoke arm (122) pivoting on flange(120) vertically bent extensions and a threaded knob (124). In one configuration the threaded knob (124) has a spiked end to be able to pierce the glass in the event of an explosion. The flange (120) has perimeter mounting holes. In this instant the flange is made from aluminum; however, other materials will work equally well. Mounting bolt holes will accommodate ¼ inch diameter fasteners, but the holes can be drilled to accommodate other size fasteners. The thickness of the dome glass is 0.03-0.25 inches, although other thicknesses and shapes of the glass will work equally well including treatment of the glass to enhance instant shattering.

Referring now to FIG. 2 for a representation of a smaller tubular ampoule full of the pig blood mixture placed in a sealed end oblong cross sectioned tube approximately ½ inch in diameter for mounting to walls and ceilings of public transportation vehicles over seats (200). The tubular glass (210) will hold the pig blood mixture (230). The glass will have a perimeter widening to snugly drop into a flange (220). A glass seals the pig blood mixture in a flattened tubular fashion in this embodiment; however, other enclosure configurations can work equally well. The flange (220) has an extrusive rim (225) which can be stamped as part of the original flange (220) or can be fastened to the original flange in order to hold the tubular glass (210). The flange (220) has perimeter mounting holes. In this instant the flange is made from aluminum; however, other materials will work equally well. Mounting bolt holes will accommodate ¼ inch diameter fasteners, but as an alternative the holes can be drilled to accommodate other size fasteners. In this instant the flange has the glass tube retainer (225) attached to flange (220); however other configurations will also work to hold the glass tube (210) against the flange (220). For public transportation overhead applications, a plastic member or equivalent impregnated with the formula will also work well.

The plaque or sign in FIG. 3 has “Pig Blood” printed on it in English, Farsi, and Arabic. It will be printed on both sides to accommodate aerial dropping when the mixture is sprayed or applied via mortars, artillery shells, or bombs. Where the pig blood mixture is used to protect public buildings, these signs should be well marked at the entries. In addition they should be suspended or mounted near each ampoule.

Various mixtures of pig blood with stabilizers and clinginess can be employed; however, in the present configuration the formula is one part pig blood combined with 1 part red dye, 2 parts alcohol, and 4 parts clear asphalt emulsion or equivalent. The asphalt emulsion is oil base and provides the stickiness to cling to wherever it contacts and spread secondarily to additional contacts including people. The pig blood and possibly the red dye are water based; although oil based red dyes can also be used. The alcohol allows the pig blood and red dye to spread into and throughout the clear asphalt emulsion. Alcohol also acts as a preservative. An oil base solvent and possibly heat may be added to bring the mixture to an aerial spraying consistency. The mixture can also be loaded into mortar shells, artillery shells, and bombs for an additional means of disbursement. The blood won't retain its color over time, so the red dye is necessary to more permanently remind pig-blood sensitive terrorists of the disbursal zone.

For the overhead vial embodiment, the asphalt emulsion, which provides the sticky or clinging function for the formula, can be eliminated. For the spreading (disbursement) embodiments, the emulsion, or equivalent, will be important

It is anticipated following application of the pig blood mixture that some of the dropped signs will attach themselves to the clingy mixture. It is further anticipated that where this mixture is applied, illegal infiltrators who are not pig-blood sensitive will be easily identifiable because of the clingy mixture and possible unique signature additives. It is further anticipated that infiltrators will be sprayed with the mixture by triggering a break in signal or a trip wire. Placing these devices around secretly will have a profound deterrent effect because infiltrators will never know where they are located.

Although a preferred embodiment of the invention has been disclosed for purposes of illustration, it should be understood that various changes, modifications and substitutions may be incorporated in the embodiment without departing from the spirit of the invention, which is defined by the claims which follow.

What is claimed is:

1. A system for deterring pig-blood sensitive terrorists, comprising a liquid mixture of pig blood and other chemicals which provide a preservative and a color function, in a container or other carrier, and which upon release, exits into the vicinity thereof.

2. A system of claim 1, including an additional chemical providing a signature function.

3. The system of claim 1, including a blend of oil base clear asphalt emulsion and/or other product(s) for additional permanence and/or clinging capability

4. The system of claim 1, wherein the liquid is contained in an ampoule for release by explosion.

5. The system of claim 2, wherein the liquid is contained in an ampoule for release by explosion.

6. The system of claim 2, wherein the liquid is thinned using oil base solvents to allow it to be spread by spraying.

7. The system of claim 2, wherein the liquid is contained in mortar shells for distribution.

8. The system of claim 2, wherein the liquid is contained in artillary shells for distribution.

9. The system of claim 2, wherein the liquid is contained in bombs for distribution.

10. The system of claim 2, wherein the liquid is contained in trip wire or signal triggered hidden devices for immediate distribution.

11. The system of claim 1, wherein signs indicating pig blood are placed or dropped in the liquid mixture distribution area.
